(19) United States
(12) Patent Application Publication
(10) Pub. No.: US 2023/0277009 A1
(43) Pub. Date: Sep. 7, 2023

(54) Automated Pizza-Making Apparatus and Method

(71) Applicant: Piestro, Inc., Santa Monica, CA (US)

(72) Inventors: Massimo Noja, North Hollywood, CA (US); Darian Montague Ahler, Los Angeles, CA (US); Matthew David Williams, Los Angeles, CA (US); Mengxi Ren, Los Angeles, CA (US); Vahid Alizadehyazdi, Long Beach, CA (US); Ruslan Tita, Culver City, CA (US); Glen Holt Humphrey, North Hills, CA (US); Evan Robert Jonisch Lowell, Los Angeles, CA (US); Jeffrey Bull, Naperville, IL (US); Daniel Tagtow, Austin, TX (US); Kyle N. Cothern, Long Beach, CA (US); Trevor Taro Yamamoto, Los Angeles, CA (US); Roy Melling, Borrego Springs, CA (US)

(21) Appl. No.: 18/111,558

(22) Filed: Feb. 18, 2023

Related U.S. Application Data
(60) Provisional application No. 63/312,132, filed on Feb. 21, 2022.

(51) Int. Cl. A47J 44/00; A21C 9/04; A21C 15/04; B65B 25/00; B65B 43/26; B65B 43/44; G06Q 50/12; G07F 11/70

(52) U.S. Cl. CPC A47J 44/00; A21C 9/04; A21C 15/04; B65B 25/00; B65B 43/26; B65B 43/44; G06Q 50/12; G07F 11/70

(57) ABSTRACT

An automated pizza-making system builds and bakes a pizza according to a customer order. The system includes a pizza assembly route and a plurality of ingredient dispensing stations for dispensing ingredients onto the pizza along the route. The uncooked pizza is automatically transferred to the oven for cooking. After the pizza is cooked, the system automatically slices and boxes the cooked pizza. A motion translator places the closed pizza box containing the pizza in a storage locker for customer pickup. A computing device is operable to manage the orders, manage the cooking steps for preparing each order, controls each functional station to build, cook, box, and store the pizza, and notify the customer for pickup when the pizza is ready. Related methods are also described.

### CROSS-REFERENCE TO RELATED APPLICATIONS

This application claims priority to provisional patent application No. 63/312,132, filed Feb. 21, 2022, and entitled “Automated Pizza-Making Apparatus and Method”, which is incorporated herein by reference in its entirety for all purposes.

### BACKGROUND OF THE INVENTION

### 1. Field of the Invention

This invention relates to food preparation systems, and more particularly, to automated pizza-making systems adapted to provide freshly prepared pizza without human interaction.

### DESCRIPTION OF RELATED ART

Fresh pizzas are typically prepared by restaurant employees. The restaurant employee takes an order; manually adds sauce, cheese and toppings to the shaped dough according to the order; places the uncooked pizza in the oven; removes the cooked pizza from the oven; slices the pizza; places the cooked pizza in a box; and places the box into hot storage. The process relies heavily on employee labor, is prone to inconsistencies, and is not scalable for multiple orders.

There is therefore a need for an improved pizza-making system, and particularly, one that is fully automated.

### SUMMARY OF THE INVENTION

In embodiments of the invention, an automated pizza-making system for preparing a pizza includes a plurality of functional stations arranged along a pizza assembly route for dispensing, cooking, cutting, and boxing the pizza.

In embodiments of the invention, the pizza-making system further includes a multi-axis pizza translator to transfer the cooked pizza into a designated storage space (optionally a hot storage) for customer pickup.

In embodiments of the invention, the automated pizza-making system includes computer system and electronics programmed and operable to control the functional stations to prepare a pizza according to a customer order, and notify the customer when the order is ready for pickup.

In embodiments of the invention, the automated pizza-making system includes a touchscreen and/or mobile display in communication with the computer system and is operable to, amongst other things, show and update the menu; receive a customer order, display current orders in progress, display an order queue, and receive payment information.

In embodiments of the invention, the functional stations of the pizza-making system are mounted in a fixed arrangement within a transportable pod or enclosure.

In embodiments of the invention, the system comprises a power distribution circuit comprising a power receptable or outlet operable to accept an AC power supply from an external source, a rectifier, and a plurality of conductor paths to distribute power to each of the functional stations and the computer system.

In embodiments of the invention, the system comprises a frame to which each of the plurality of functional stations are mounted.

In embodiments of the invention, the pod defines a footprint, and the plurality of functional components are arranged within the pod in a configuration that occupies the entire footprint, thereby prohibiting a worker from fitting within the pod during operation.

In embodiments of the invention, the ingredient dispensing stations are arranged in a fixed position relative to the pizza assembly path.

In embodiments of the invention, the system comprises a transparent window through which the pizza assembly path is visible from the outside of the pod.

In embodiments of the invention, the boxing station comprises a magazine of flat packed boxes, and operable to deploy one flat packed box from the magazine to a pizza loading stage.

In embodiments of the invention, the boxing station is operable to unflatten the flat packed box, thereby defining a cavity to receive the cooked pizza.

In embodiments of the invention, the boxing station is operable to close the upright box.

In embodiments of the invention, the boxing station includes an arm member operable to rotate a window about a hinge, thereby closing the box.

In embodiments of the invention, the pizza cutting station comprises a turntable for rotating the pizza, a blade adjustable in the vertical and horizontal directions, and wherein the computer system is operable to control the blade and turntable to create predefined cut pattern in the cooked pizza. In embodiments of the invention, the pre-defined cut pattern comprises a plurality of angularly-distributed, elongate linear cuts extending through the center of the pizza, each of which terminates an off-set distance from the edge of the pizza, and optionally, the off-set distance is at least 0.25 inches.

In embodiments of the invention, the blade is a rotatable, and wherein the pizza cutting station comprises a cleaner assembly, and wherein the computer system is operable to rotate the blade through the cleaner assembly to wipe the blade clean.

In embodiments of the invention, the system comprises a pizza tray removal station for separating the pizza dough from the tray after cooking.

In embodiments of the invention, a pizza box comprises a bottom and top, opposing side walls joined to the bottom and top at seams, and opposing side windows joined to the bottom by hinges.

In embodiments of the invention, the pizza box comprises a first flat packed configuration in which the top is in contact with the bottom, and the opposing side windows are rotated outward.

In embodiments of the invention, the pizza box comprises a second upright unflattened configuration in which the top and bottom and opposing side walls define a cavity for accepting a pizza.

In embodiments of the invention, the pizza box comprises a third closed configuration in which the opposing side windows are rotated about the hinges towards the top, thereby enclosing the cooked pizza. In embodiments of the invention, the side windows comprise tabs, and the top comprises slots that are arranged to engage the tabs when the side windows are rotated to a target angle in the third configuration, thereby locking the cooked pizza in the cavity.

In embodiments of the invention, a self-contained portable automated pizza-making system comprises a first group of functional stations defining a cold pizza flowpath, and a second group of functional stations defining a hot pizza flowpath, and a computer system operable with the functional stations to prepare a pizza for cooking along the cold pizza flowpath, and cook and box the pizza along the hot pizza flowpath.

In embodiments of the invention, the cold pizza flowpath is arranged on a first frame such that the cold pizza flowpath may be separated from the hot pizza flowpath as a first unit, and optionally, the hot pizza flowpath is also arranged on a second frame to form a second unit.

In embodiments of the invention, the footprint of the cold pizza flowpath is less than or equal to half the overall footprint of the system.

In embodiments of the invention, the system further comprises a transparent window to view the cold flowpath.

In embodiments of the invention, a method for servicing a portable self-contained automatic pizza-making system comprises a first group of functional stations defining a cold pizza flowpath, and a second group of functional stations defining a hot pizza flowpath, and a computer system operable with the functional stations to prepare a pizza for cooking along the cold pizza flowpath, and cook and box the pizza along the hot pizza flowpath, and wherein the cold pizza flowpath is arranged on a first frame such that the cold pizza flowpath may be separated from the hot pizza flowpath as a first unit from the hot pizza flowpath, and the method comprising the steps of: separating the cold pizza flowpath as a first unit from the hot pizza flowpath; and refilling at least one of the functional stations with ingredients, and optionally cleaning at least one of the functional stations.

In embodiments of the invention, a method for automatically boxing a pizza comprises unflattening a flat packed box to form a cavity comprising a front window, rear window, top, bottom, and opposing side walls; advancing the pizza through the front window and into the cavity; and enclosing the pizza in the box by closing the front and rear windows about hinges.

In embodiments of the invention, the method further comprises locking the windows via tab members.

In embodiments of the invention, the step of unflattening is performed by pushing on seams of the opposing side walls of the flat packed box from opposite directions, causing the top to separate from the bottom.

In embodiments of the invention, the unflattened box defines a maximum volume, and the step of enclosing is performed within the maximum volume.

In embodiments of the invention, the method further comprises singulating the flat packed box from a magazine of vertically stacked flat packed boxes.

In embodiments of the invention, a non-transitory storage medium, having a set of computer-readable instructions stored thereon for receiving a customer order for a pizza, building a pizza according to the customer order, cooking and boxing the pizza, and placing and storing the pizza in an available location for customer pickup as described herein.

Objects and Advantages of some embodiments of the invention include:
Making and delivering a custom-ordered 10″ pizza from scratch in under ten minutes, more preferably under 6 minutes, and in some embodiments, under five minutes; and in some embodiments, and except for the oven station, performing each individual functional pizza making step in under 45 seconds, and more preferably under 30 seconds.
Holding and dispensing enough ingredients in their proper environments to make at least 80 pizzas before needing to be refilled or serviced;
Sizing and arranging the stations of the entire pizza-making system within a transportable footprint less than or equal to 10′ W×6′ D×7′ H, and more preferably less than or equal to 108″ W×60″ D×76″ H;
Designing and arranging the stations such that all food contact areas are food-safe, accessible to an operator, and cleanable;
Storing all ingredients in a food-safe manner;
Arranging the station areas that need to be regularly accessed for refilling to be easily accessible by human workers; and
optionally, computer vision/robot-free.

The description, objects and advantages of the present invention will become apparent from the detailed description to follow, together with the accompanying drawings.

### BRIEF DESCRIPTION OF THE DRAWINGS

FIG. 1 is a front right-side isometric view of an automated pizza-making system in accordance with an embodiment of the invention;

FIG. 2 is a partial front right-side isometric view of an automated pizza-making system with the exterior removed in accordance with an embodiment of the invention;

FIG. 3 is a partial rear top-side isometric view of an automated pizza-making system with the exterior removed in accordance with an embodiment of the invention;

FIG. 4 is a top view of a pizza-making system illustrating a cold and hot pizza-making routes in accordance with an embodiment of the invention;

FIG. 5 is a flow chart of a method for making a pizza in accordance with an embodiment of the invention;

FIG. 6 is a perspective view of a dough station in accordance with an embodiment of the invention;

FIG. 7 illustrates a pizza translator in accordance with an embodiment of the invention;

FIGS. 8-11 are front perspective views of the various functional stations of the automated pizza-making system in accordance with an embodiment of the invention;

FIG. 12 illustrates an oven loading translator in accordance with an embodiment of the invention;

FIG. 13 is a perspective view of an oven station in accordance with an embodiment of the invention;

FIGS. 14A-14B illustrate sequentially a pizza tray splitter station disposing the tray after the pizza has been separated from the tray in accordance with an embodiment of the invention;

FIG. 15 is a perspective view of a pizza slicer station in accordance with an embodiment of the invention;

FIG. 16 is a perspective view of a pizza boxing station in accordance with an embodiment of the invention;

FIG. 17A is a top view of a pizza box in an unassembled, unpacked configuration in accordance with an embodiment of the invention;

FIG. 17B is a top view of the pizza box shown in FIG. 17A in an assembled, flat pack configuration in accordance with an embodiment of the invention;

FIGS. 17C-17D are perspective views of the pizza box shown in FIG. 17B in an open and closed configuration, respectively;

FIGS. 18A-18B illustrate rear and front-left side perspective views, respectively, of a smart storage station for boxed cooked pizzas in accordance with an embodiment of the invention;

FIG. 19 is a hardware block diagram of an automated pizza-making system in accordance with an embodiment of the invention; and

FIG. 20 is a software architecture diagram of a pizza-making system in accordance with an embodiment of the invention.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit, or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Last, it is to be appreciated that unless defined otherwise, all technical and scientific terms used herein have the same meaning as commonly understood by one of ordinary skill in the art to which this invention belongs.

Apparatus Overview

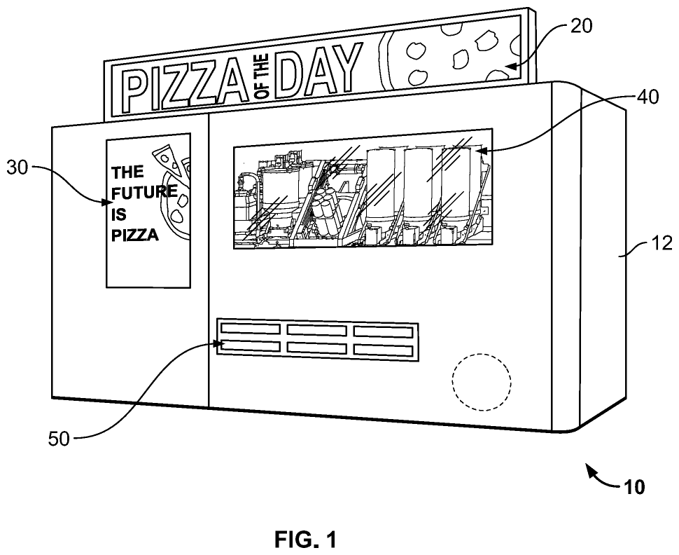

FIG. 1 shows an automated pizza-making system 10 in accordance with an embodiment of the invention. The system 10 shown in FIG. 1 includes a body 12, a menu and queue screen 20, an order screen 30, a transparent window 40 for customers to see the food construction area, and a smart storage area for customers to pick up their cooked boxed pizza.

The body 12 is shown having a cube or box-like shape. Body 12 can be formed by mounting custom panels to a frame (not shown). The frame is affixed to a chassis or floor (not shown). An exemplary material for the panels, floor and/or frame is steel. In embodiments of the invention, the pizza-making system 10 is configured to occupy a space of less than or equal to 108″ W×60″ D×76″ H. Additionally, the functional stations operating within the body are arranged and mounted to the frame and body such that the whole system 10 can be transportable as a single unit (or pod) from one location to another via trailer or other conventional transportation means.

Additionally, as discussed further herein, a wide range of electronic and computer components can be enclosed within the body or enclosure 12 and/or mounted to the frame for controlling the various stations, collecting and storing data, and communicating with the customers or staff.

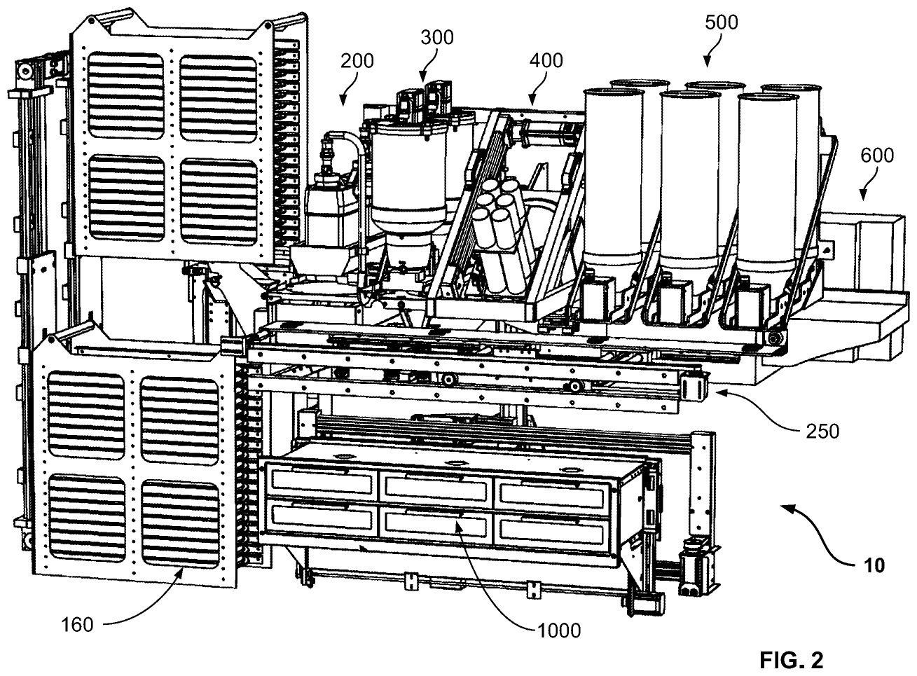

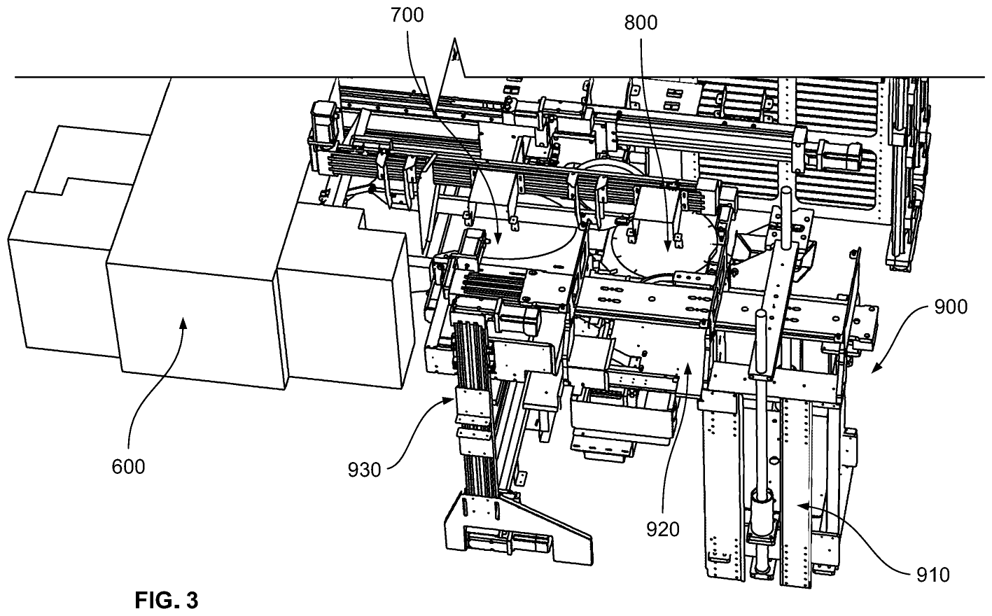

With reference to FIGS. 2 and 3, a front and rear partial view of pizza-making system 10, 900 is shown respectively with the body 12 removed to illustrate the various functional stations or modules contained therein. As will be discussed in more detail, in embodiments of the invention, functional stations include dough storage station 160, sauce dispensing station 200 and pizza translator to move the pizza from one station to the next, cheese dispensing station 300, pepperoni dispensing station 400, toppings dispensing station 500, pizza cooking station 600, tray removal station 700, pizza cutting station 800, boxing station 900, and smart storage station including pickup lockers 1300.

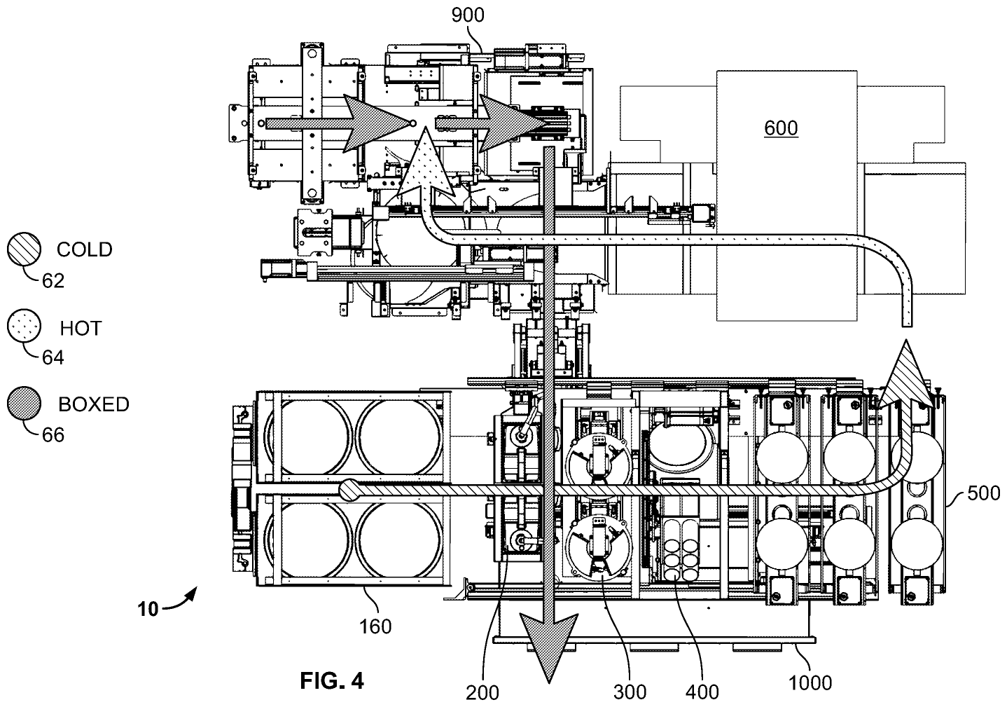

With reference to FIG. 4, a top view of the pizza-making system 10 with the cover 12 removed is shown. A pizza-making route in accordance with an embodiment of the invention is illustrated characterized by three sections including cold assembly/build path 62, hot workflow path 64, and boxed workflow path 66. The functional stations are arranged along the paths from dough storage 160 to smart storage for customer pickup 1300. In the embodiment shown in FIG. 4, cold and hot workflow paths are constructed to be separable from one another as units for servicing (e.g., cleaning, refilling, repairing, etc.). To this end, each of the components associated with the cold path are arranged on a first frame, and each of the components associated with the hot path are arranged on a second frame. In embodiments of the invention, each workflow path occupies about half of the overall footprint of the pod, and does not leave room for a worker when the system is installed in the pod.

Method Overview

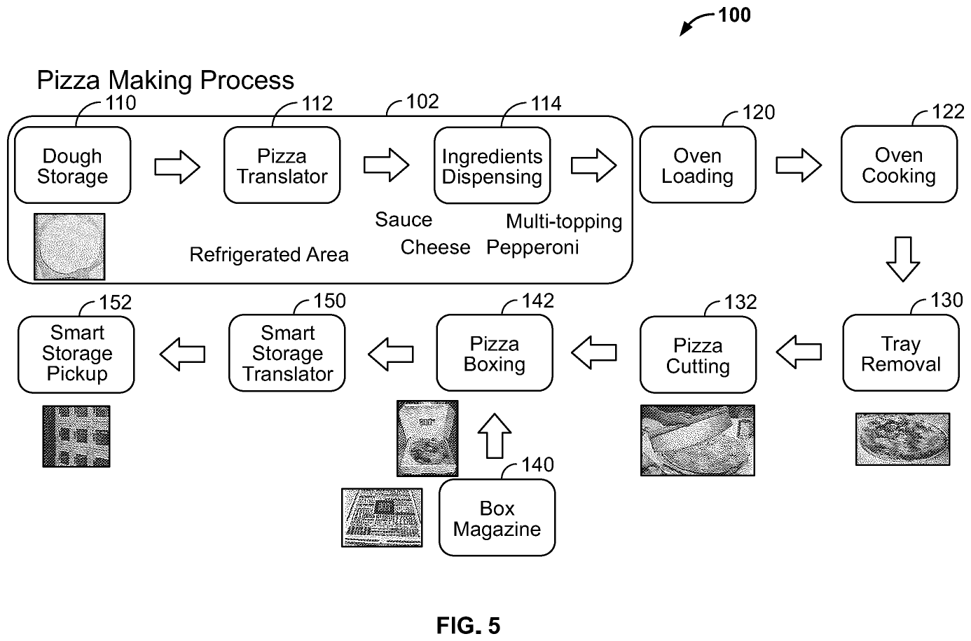

FIG. 5 shows a flow chart of a method 100 of making pizza in accordance with an embodiment of the invention.

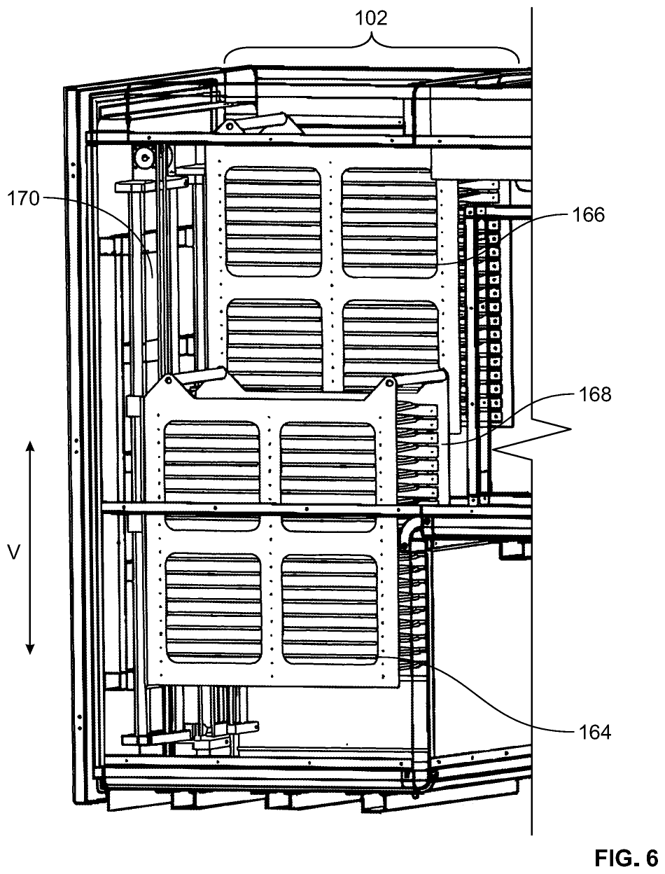

Step 110 states dough storage. This step may be performed using the dough storage station 160 shown in FIG. 6. Dough storage station 160 is shown including a refrigerated area 102 holding two racks 164, 166 filled with pizza doughs 168. Typically, each dough sits on a conventional pizza tray and the dough tray assemblies are loaded into the racks 164, 166 by a worker during the initial pod setup or stocking.

In embodiments of the invention, each rack is sized 2 doughs deep ×20 doughs high and capable of holding 40 flattened (preferably, fresh-frozen) pizza doughs 168. Thus, the two racks 164, 166 can collectively hold up to 80 doughs.

The dough storage station 160 also includes linear actuators 170. Linear actuators are operable as elevators, lifting and lowering (V) the racks of dough as needed for refilling, servicing or operation, discussed further herein.

Pizza Translator

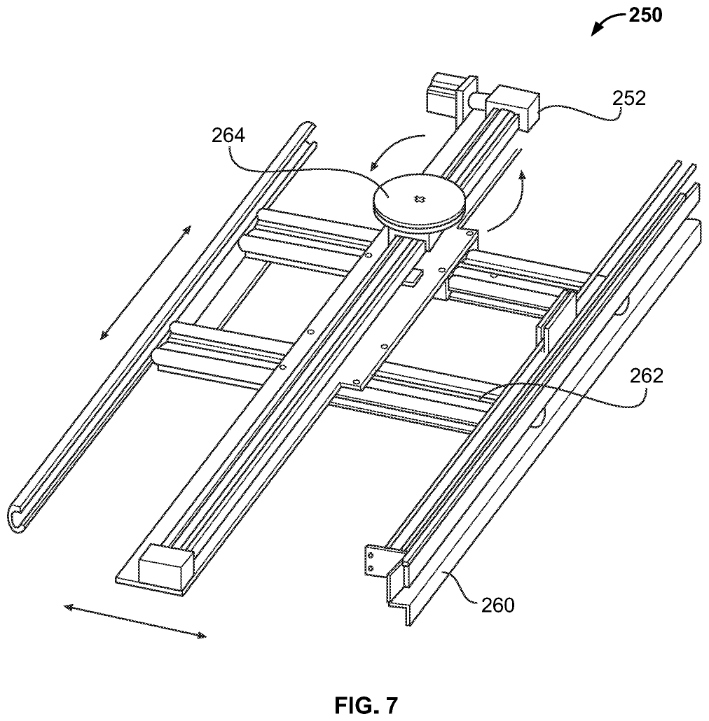

Step 112 states pizza translator. This step may be performed using the pizza translator 250 shown in FIG. 7. When a pizza is ordered, as discussed further herein, pizza translator 250 cantilevers arm 252 under one of the dough racks, where the rack then drops low enough so a single dough/tray assembly is placed on the arm 252. The pizza translator 250 then takes the dough along the cold assembly route to build the pizza as ordered. The pizza is moved along the cold assembly route under each of the ingredient dispensers described herein.

The pizza translator shown in FIG. 7 includes linear actuators 260, 262 for X/Y-axis motion, and rotational actuator for rotating tray 264 about the Z-axis.

Ingredient Dispensing

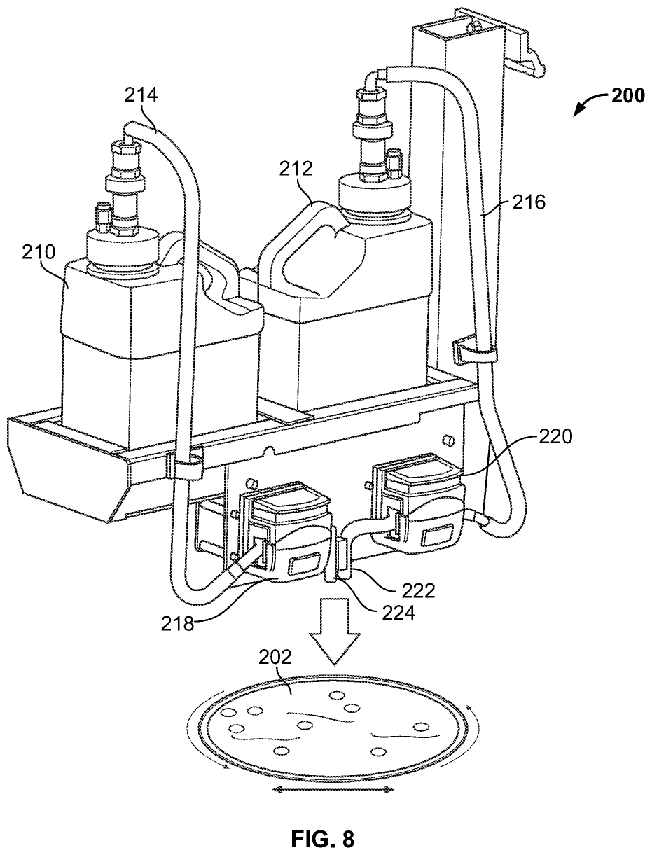

Step 114 states ingredients dispensing. This step may be performed using the stations shown in FIGS. 8-11 in combination with positioning the dough underneath each of the ingredient dispensing stations using the pizza translator 250, described above.

Sauce Dispensing Station

With reference to FIG. 8, an enlarged view of a sauce dispensing station 200 for dispensing sauce onto the dough 202 is shown in accordance with an embodiment of the invention. Sauce station 200 includes two containers 210, 212 (e.g., two 2.5 gallon containers). Hoses 214, 216 are shown extending from the tops of the containers to peristaltic pumps 218, 220. Nozzles 222, 224 aim the sauce towards the dough 202. The dough 202 is positioned under the nozzles.

As the ingredient is dispensed from the nozzles, the dough is rotated 360 degrees after which the dough is moved in either the X (or Y) direction such that the ingredient is distributed evenly across the entire surface of the dough.

Additionally, the whole station is removable for replacing, cleaning, servicing or refilling.

Cheese Dispensing Station

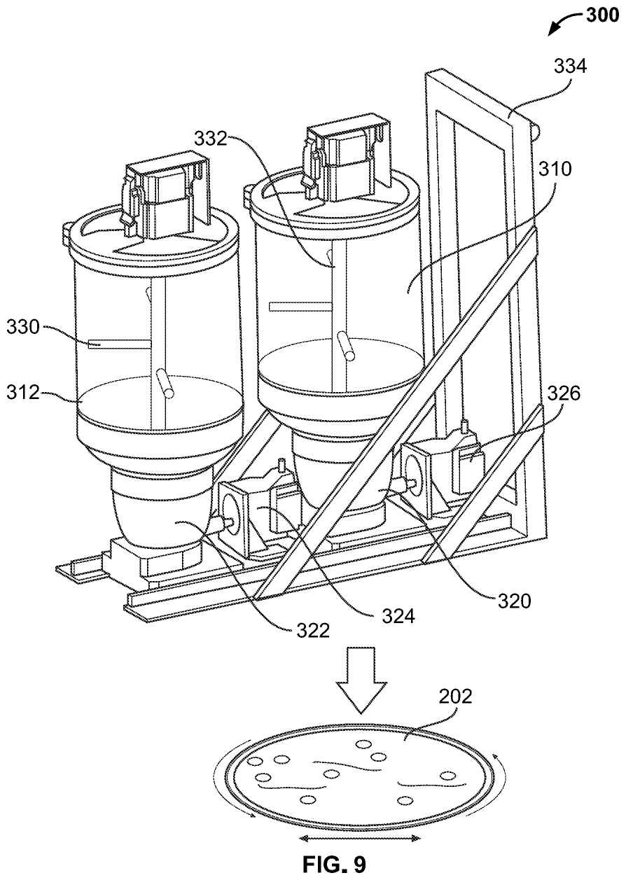

With reference to FIG. 9, an enlarged view of a cheese dispensing station 300 for dispensing cheese onto the dough 202 is shown in accordance with an embodiment of the invention. The cheese dispensing station shown in FIG. 9 includes two containers 310, 312 for holding the cheese.

Each container includes a rotating paddle wheel 320, 322 powered by an electric motor 324, 326. An agitator 330, 332 is located in the middle of each container, rotatable around the vertical axis, to prevent bridging or clumping of the ingredients.

As the ingredient is dispensed from the nozzles, the dough is rotated 360 degrees after which the dough is moved in either the X (or Y) direction such that the ingredient is distributed evenly across the entire surface of the dough.

Dispensing is adjustable by changing the paddle wheel and agitator speeds.

Additionally, the whole rack 334 is removable from the system frame. The motor and parts of the cheese dispensing station are also detachable for cleaning or servicing.

Pepperoni Dispensing Station

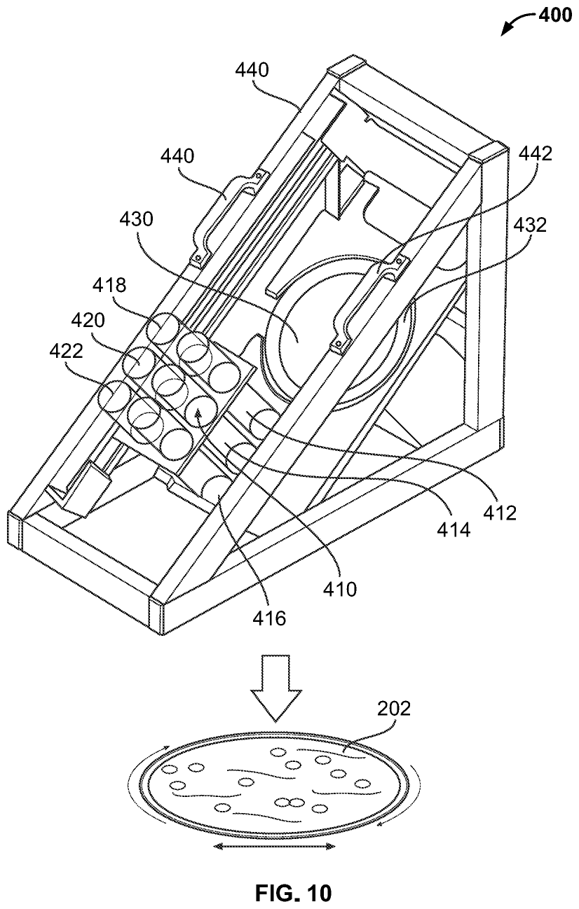

With reference to FIG. 10, a pepperoni dispensing station 400 for freshly slicing and dispensing pepperoni onto the dough 202 is shown in accordance with an embodiment of the invention.

The pepperoni dispensing station 400 shown in FIG. 10 includes a magazine 410 supporting six tubes 412, 414, 416, 418, 420, 422, each adapted to hold a one-foot-long pepperoni log. The logs are placed into each tube on the magazine during setup.

In operation, the logs slide into the blade 430. The blade spins, and cuts each of the pepperoni logs to about a 1/16-inch slice of pepperoni. The slices fall from the blade directly onto the pizza dough 202. As the slices fall, the dough is rotated 360 degrees after which the dough is moved in either the X (or Y) direction such that the ingredient is distributed evenly across the entire surface of the dough.

The whole station 400 is removable from the system 10. Once the wires are disconnected, one can grab the handles 440, 442 and lift it out of the system. Additionally, the blade 430 and blade guard 432 can be removed like a traditional deli slicer for cleaning.

Multi-Topping Dispensing Station

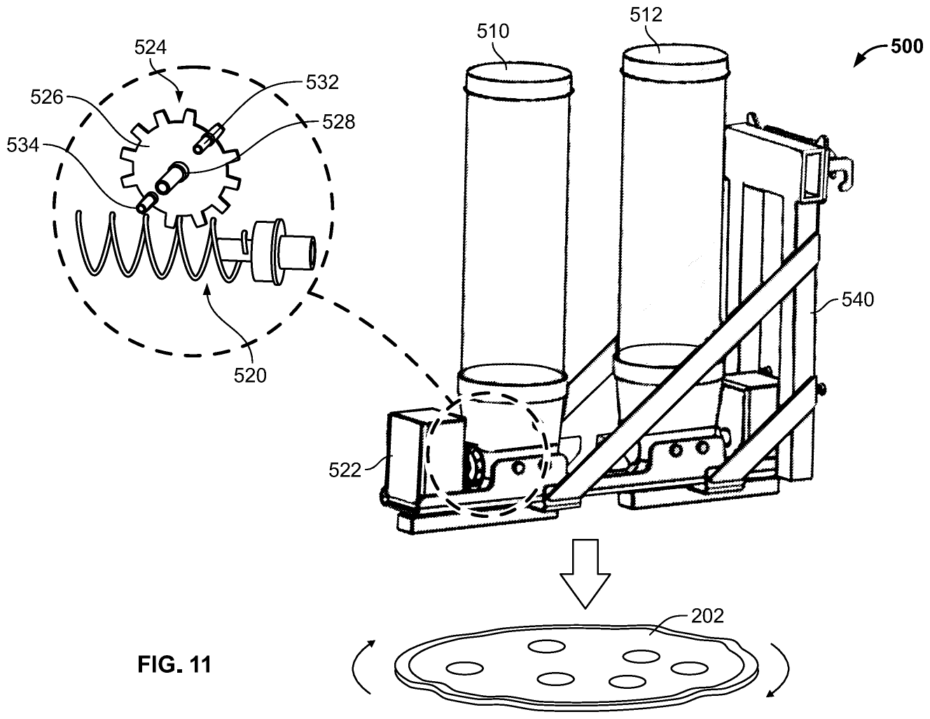

With reference to FIG. 11, a multi-topping dispensing station 500 for dispensing multiple types of toppings onto the dough 202 is shown in accordance with an embodiment of the invention. The topping dispensing station 500 shown in FIG. 11 includes two containers 510, 512 for holding the various ingredients. The ingredients are dispensed via a horizontal screw feed 520 arranged at the bottom of each container. The screw feed or auger is powered by an electric motor 522.

An agitator 524 is also shown located in the middle of the container, driven by the screw feed 522, to prevent bridging or clumping of the ingredients. Agitator is shown in the form as a flat gear 526, axis 528, and arms 532, 534 for contacting the ingredients when the gear is rotated about the axis. By adjusting the size of screw feed and agitator (e.g., the diameter and pitch), the station 500 is capable of dispensing ingredients having different sizes.

As the ingredient is dispensed onto the dough, the dough is rotated 360 degrees after which the dough is moved in either the X (or Y) direction such that the ingredient is distributed evenly on the dough.

The whole rack assembly 540 can be removable from pizza-making system 10. The individual components are coupled together such that they may be easily disassembled for cleaning or servicing. Optionally, drip pans are placed under each container to drain water from the ingredients.

Oven Loading

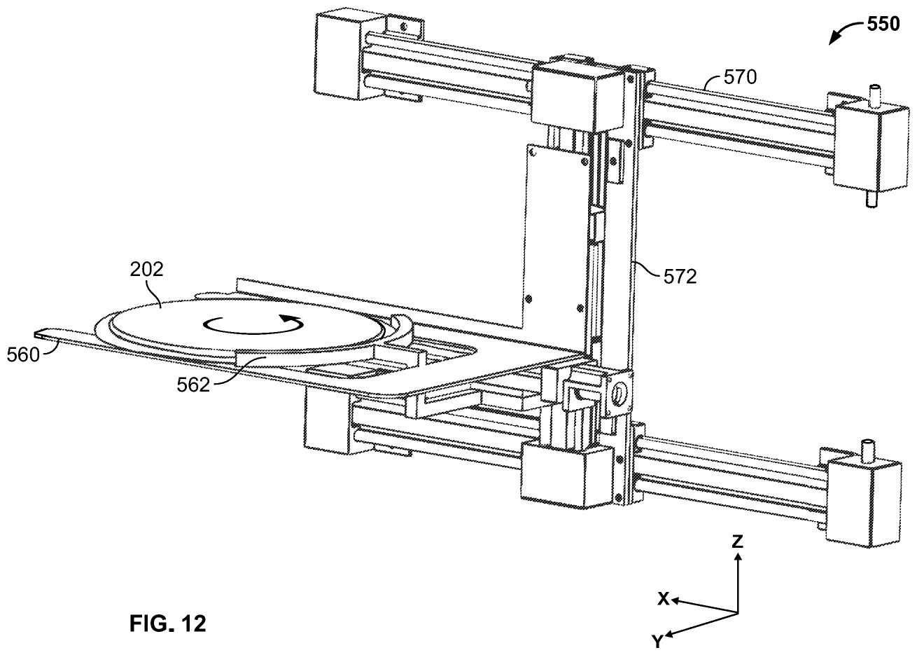

With reference again to FIG. 5, step 120 states oven loading. This step may be performed by oven loading translator 550 shown in FIG. 12. The oven loader translator 550 is shown including a forked tray holder 560 to support the built pizza/tray assembly 202, a pusher 562 operable to push the pizza off the forked tray holder, a traverse or X-motion linear actuator 570, and vertical or Z actuator 572. In embodiments of the invention, oven loading translator 550 is operable to (a) lift the uncooked built pizza and pizza screen from the pizza translator 252 (shown in FIGS. 2, 7, discussed above) using the fork shaped arms 560; (b) move the pizza to an opening between the cold side and the hot side of the system; and (c) push the pizza 202 using the pusher 562 through the opening onto the oven's belt conveyor. After the pizza is delivered to the oven's conveyor, the opening can be closed to prevent heat from escaping from the oven and warming the cold side.

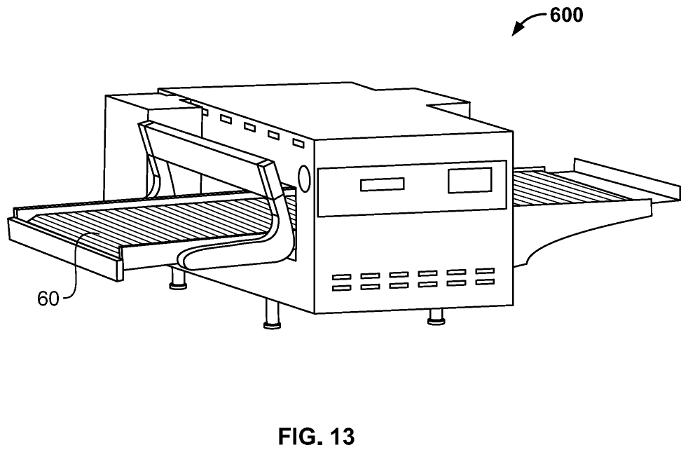

Step 122 states oven cooking. This step may be performed with an oven 600 as shown in FIGS. 2, 3, 4 and 13. The oven 600 shown in FIG. 13 includes a conveyer 610 onto which the pizza is placed using oven loading translator described above. The oven is preferably insulated from the cold side of the system with a wall. An example of an oven that may be used in the system of the present invention is the Shuttle® S1200, manufactured by Ovention Inc. (Milwaukee, Wis.).

Tray Removal

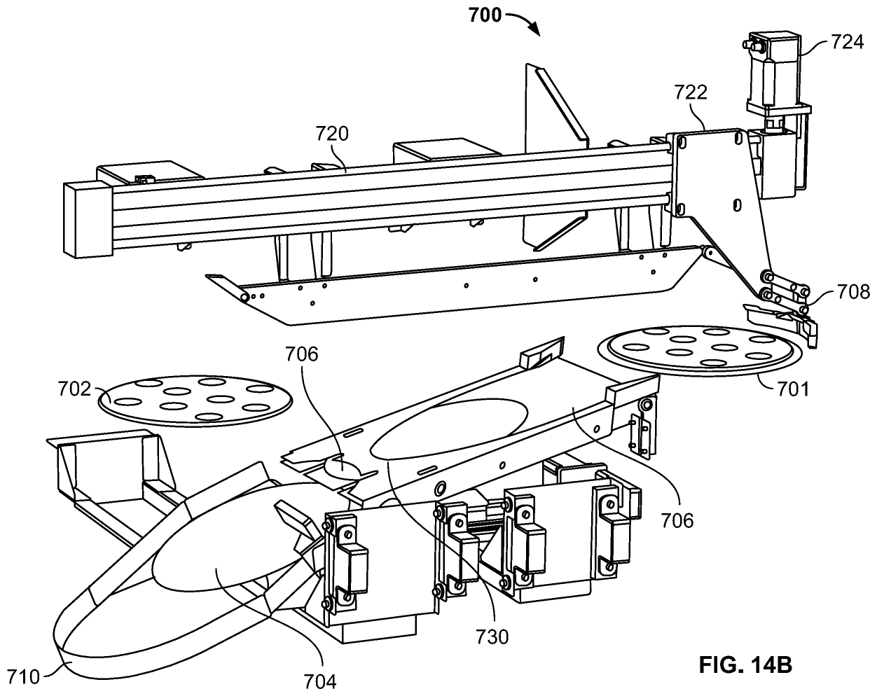

Step 130 states tray removal. This step may be performed using a tray splitter 700 as shown in FIGS. 3, 14A and 14B. After cooking, the pizza is separated from the metal tray on which it was prepared and cooked.

With reference to FIG. 14A, the cooked pizza tray assembly 701 is urged onto separator bed 706 by arcuate member 708 until tray is halted by stop 706 while the pizza 702 continues to be pushed off the tray and onto the pizza slicer (not shown). The arcuate member is driven by carriage 722 along rail 720 and powered by electric motor 724.

With reference to FIG. 14B, and after the pizza 702 has been separated from the tray 704, the separator bed 706 is tilted downward via link member 730, dropping the tray 704 into a bin (not shown) for removal during servicing. Optionally, a band 710 is arranged above the bin to catch and guide the falling tray into the bin.

Pizza Cutting

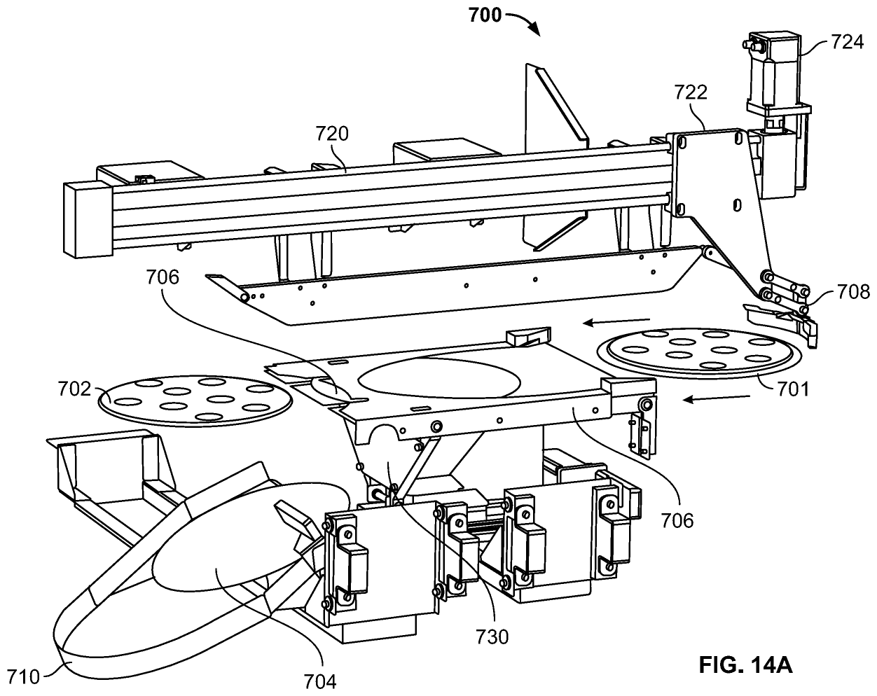

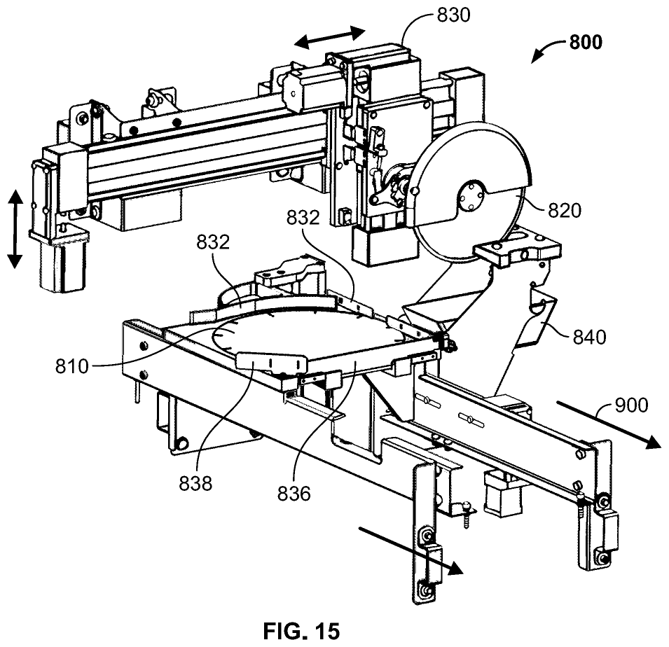

Step 132 states pizza cutting. This step may be performed using a pizza slicer 800 as shown in FIGS. 3 and 15. Pizza slicer 800 is shown including a rotating bed 810, spinning blade 820 mounted on a XY translator 830, pizza pusher 832, stops 834, 836, 838, and cleaning basin 840.

In operation, the pizza rests on the rotating bed 810, where spinning blade 820 descends on the pizza, cutting across the width of the pizza, preferably scoring the pizza in the middle while leaving the crust intact. In embodiments of the invention, the pizza is scored to within an off-set distance of the edge. Preferably the off-set distance ranges from 0.25 to 0.5 inches.

After the initial pass from the blade, the pizza rotates an angle (e.g., 60 degrees), and the blade repeats the slice. The pizza is rotated and sliced additional times to cut the pizza into a plurality of slices, preferably 6-10 slices.

The spinning blade retracts back into its resting/home position shown in FIG. 15, where it will rotate through a cleaning assembly/mechanism (e.g., a brush, wedge, or scraper) that will remove cheese and debris from the blade before the next pizza needs to be sliced. Debris are captured in basin 840.

Stop member 836 is operable to pivot or open. The cut pizza is then pushed by pusher member 832 to the next station, described herein.

Boxing Station

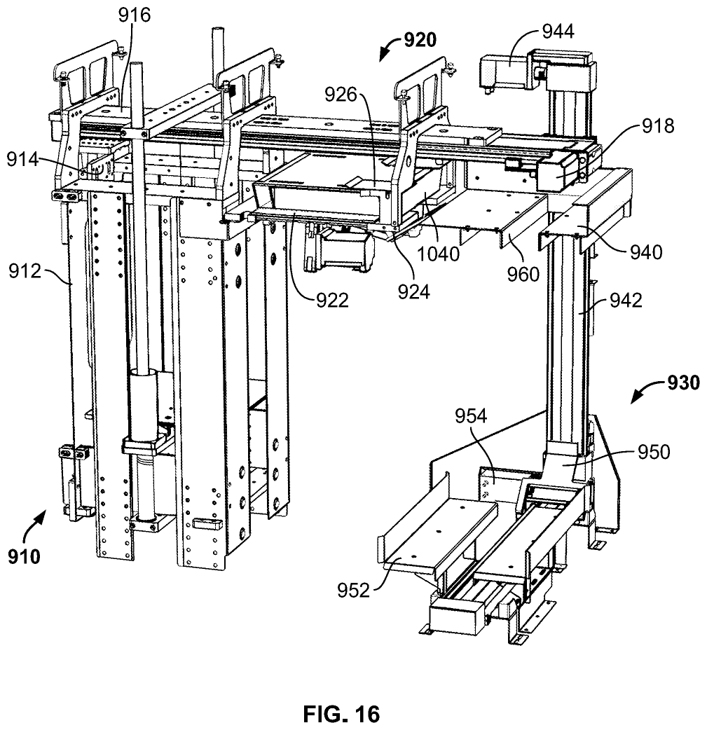

Step 142 of the method 100 states pizza boxing. This step may be performed using a boxing station 900 as shown in FIGS. 3 and 16. The boxing station 900 is shown including a box storage area 910, box folding area 920, and a box elevator area 930.

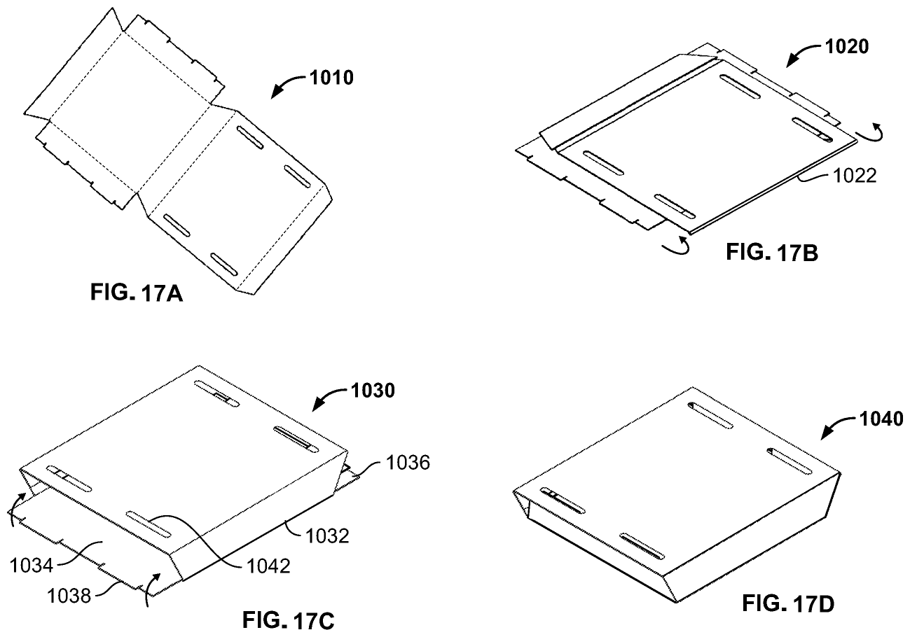

In embodiments of the invention, the box storage area includes a box magazine 912 adapted to store 80 flat pack boxes. An example of a flat pack box in accordance with an embodiment of the present invention is flat pack box 1020 shown in FIG. 17B.

When required, the topmost flat pack box is pushed out of the magazine 910 by box pusher 914 and into the box folding area 920. Box pusher is shown supported by rail 916 and powered by motor 918.

Box folding area 920 includes a floor for supporting the box, opposing pivotable side arms (e.g., arm 922), pivotable distal stop 924, and at least one fixed upper stop 926. The flat box is urged into the box folding area until it contacts distal stop 924 at which time the box is forced to unfold/unflatten into the open box configuration 1030 shown in FIG. 17C.

Optionally, in embodiments of the invention, one or more ribbon springs or guides extend from the floor of the box folding area directing the flat box upwards towards upper stops 926. As the pusher 914 continues to push the box into the box storage area, the first edge 1022 of the flat box 1020 contacts upper stops initially, causing the box to begin to unfold. As the box continues to unfold, the box lower seam 1032 rotates forward until contacting distal stop 924, resulting in the unfolded box configuration 1030 shown in FIG. 17C.

After the box is unfolded/unflattened into an “open” pizza-receiving configuration as shown in FIG. 17C, the pizza is pushed into the box via pusher 832 of the slicer station 800. The front and rear windows 1034, 1036 of the box 1030 are then folded inward about hinge areas by opposing pivotable arms (e.g., 922). Pivotable arms 922 can be moved using an electric actuator.

The box 1030 is shown having tabs 1038 and corresponding slots 1042 to receive the tabs and automatically lock the box in a closed configuration when the windows 1034, 1036 are folded to a sufficient angle (e.g., 80 to 90 degrees). FIG. 17D shows a locked/closed box 1040 in accordance with an embodiment of the invention.

Next, and with reference again to FIG. 16, the box 1040 is pushed to the elevator area 930, where the box is lowered to the smart storage area 1300, described herein. Elevator area 930 is shown including a box holder 940 to receive and support the box from the box folding area, linear rail 942 powered by actuator 944 for raising and lowering the box holder, and slider 954 for pushing the box from the box holder 940 to the smart storage when the box holder and box are in the lower position. A gap or channel 960 is present in the box holder 940 for the slider to travel therethrough and for pushing the box from the box holder.

Smart Storage

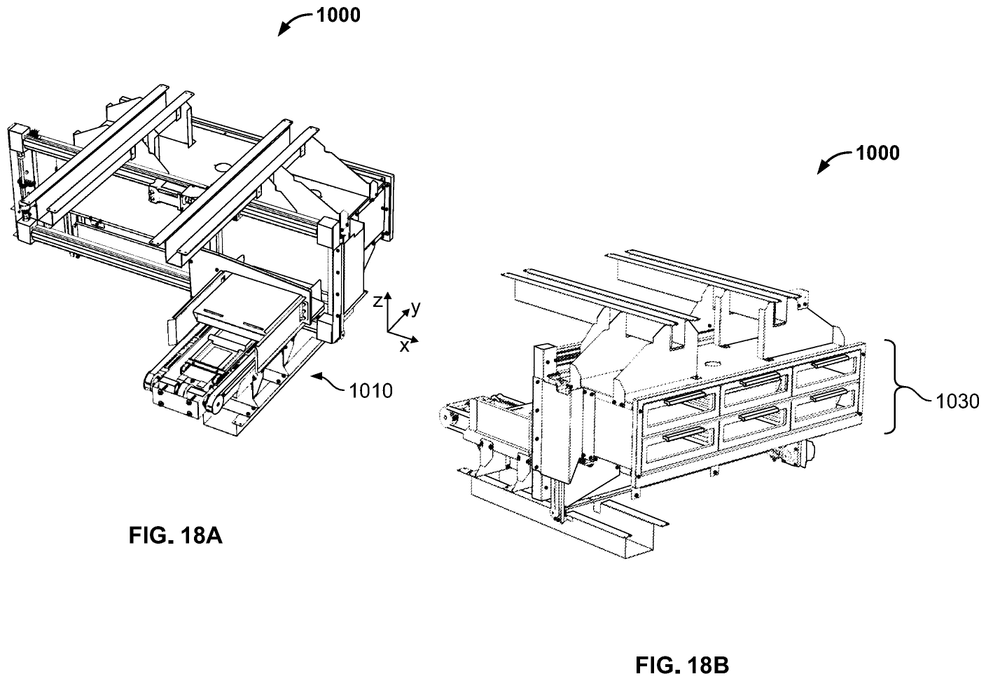

Step 150 of the method 100 states smart storage translator. This step may be performed using the smart storage station 1300 as shown in FIGS. 2, 18A, and 18B. Smart storage translator is shown including a three-axis (x, y, z) gantry system 1310 to move the finished, boxed pizza to one of a plurality of lockers 1330. Preferably the lockers are insulated and optionally, heated. Also, it is to be understood that although the smart storage 1300 shown in FIG. 18B includes six lockers the invention is not intended to be so limited and may include more or less lockers except as where recited in any appended claims.

Step 152 states smart storage pickup. This step can be performed by informing the customer when the order is ready, and which locker the order is held.

In embodiments of the invention, the customer is informed that their pizza is ready and which locker it is located in via a queue screen (e.g., screen 20, FIG. 1) or a web App.

Optionally, the lockers include doors, and the customer is assigned a PIN (or another type of authenticating factor) when they order which is provided to open the locker door. When the customer provides confirmation via the PIN, for example, by a phone App or the order menu, the appropriate locker opens, and the customer retrieves their pizza. As discussed herein, embodiments of invention track all orders including, for example, customer or order name, assigned PIN or code, order/pizza type, order time, anticipated pickup, actual pickup, available lockers, assigned lockers, etc.

Hardware Block Diagram

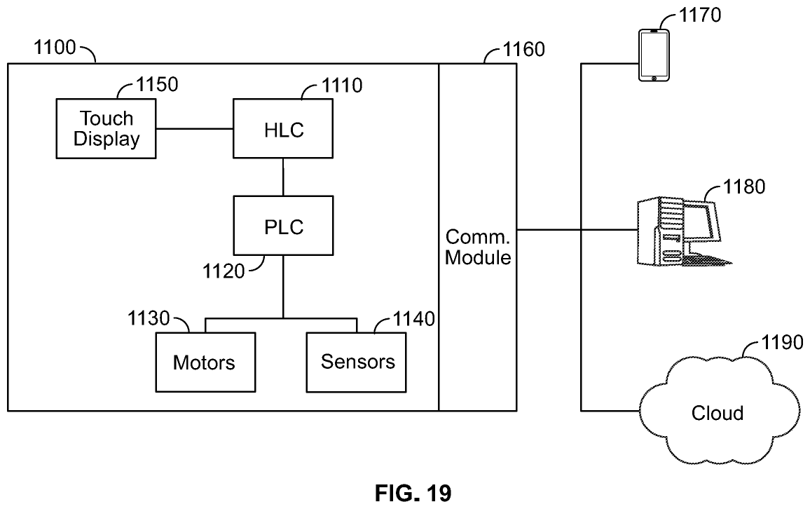

With reference to FIG. 19, a block diagram of a pizza-making system includes a pizza-making pod 1100 including at least one computing device 1110. The computing device 1110 can be a conventional micro-computer and the like including, for example, one or more processors, and memory or storage devices. In embodiments of the invention, and described further herein, the computing device 1110 is programmed and operable as a high-level controller (HLC) to, amongst other things, manage customer orders and communicate with a program logic controller (PLC) 1120.

Program logic controller 1120 is shown in communication with motors 1130 and sensors 1140. Each of the functional stations described above includes one or more motors and sensors controlled by the PLC to carry out the steps of the pizza-making method.

Also, in some embodiments, each functional station comprises its own hardware and electronics including, e.g., a dedicated controller, processor, memory, PCB, and one or more sensors. Optionally, one or more of the functional modules are self-contained functional units that are conveniently coupled to the computing system 1100. For example, in embodiments, the oven and slicer stations are self-contained units that are conveniently arranged within the pod's body, and directly connected to the computer 1110 to control the method steps as described above.

Additionally, a wide variety of sensors can be incorporated with or otherwise used with each of the modules. Examples of types of sensors include, without limitation, proximity, load, temperature, limit switch, optical or computer visions sensing.

The pod 1100 shown in FIG. 19 also includes communication module 1160. In embodiments of the invention, communication module 1160 is operable to provide wireless and/or ethernet-communication. Examples of wireless communication that the communication module 1160 is capable of performing include, without limitation, near and far wireless such as Wi-Fi, Bluetooth, UWB, cellular, etc.

The computing device can be responsive to instructions or requests from several input devices. Examples of input devices include, without limitation, the onboard touch screen or display 30, 1150, tablets and smart phone 1170, and network or web-enabled computers 1180. Instructions or requests can be entered by an operator, team member, customer, or another.

FIG. 19 also shows cloud server 1190. Such remote servers can be used to generally communicate with the system, receive and store data, upload program updates, and host an associated a website. The input devices may download a program or App to conveniently communicate with the website to place an order and monitor activity.

Additionally, although the computing device 1100 is shown in one configuration in FIG. 19, the computing device and electronic components contained in the pod 1100 may vary widely and include additional processors, rectifiers, types of memory, ports, power supplies, batteries, communications modules, motors, sensors, and other components.

In embodiments of the invention, the pod 1100 includes a single receptable to receive AC power from and external source, and distribute the power via a plurality of electrical flowpaths to each of the functional stations and computer system in the pod.

Software

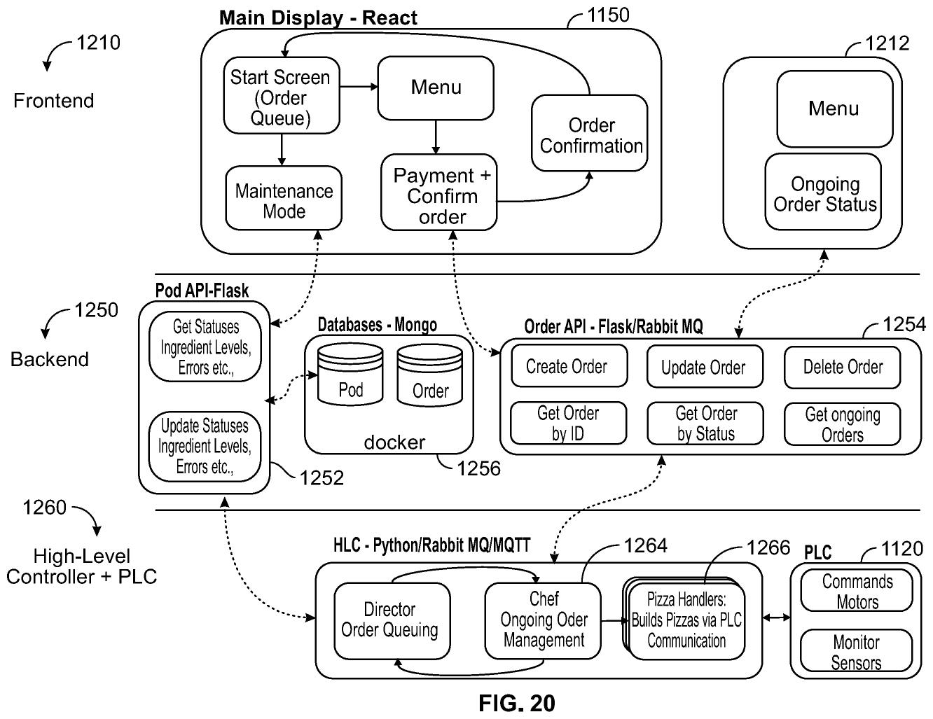

FIG. 20 shows a software architecture diagram of a pizza-making system in accordance with an embodiment of the invention. Frontend 1210, backend 1250, and high-level controller 1260 software can be stored in the pod on non-transitory and transitory memory devices and executed by the one or more processors described above.

Frontend 1210 runs main screen 1150 where the customer can place order as well as top display 1212 where they can track their order status. It also provides a control panel where the operator can perform pod maintenance. In embodiments of the invention, the frontend 1210 provides: UX/UI for pizza order (including customizing pizza); Payment handling; Telemetry data interface; and control panel for maintenance mode.

Backend 1250 is shown including pod API 1252 and order API 1254, each of which are in communication with one or more databases such as pod and order databases 1256. The backend 1250 can provide one or more of the following: Order data handling; Payment handling; Locker assignment and management; Tracking of ingredient levels; Connecting to app when nearby; Access to pod telemetry data; Maintenance mode; and Remote Monitoring (fleet management). Additionally, in embodiments, backend 1250 can contains fleet management implementation to monitor multiple pods 1100 in the cloud system 1190.

High level controller (HLC) 1260 is shown including a director module, chef module and pizza handling module for monitoring ingredient levels, order management and directing the pizza-making process, and error handling.

The director module 1262 is responsible for order queuing.

The chef module 1264 is responsible for ongoing order management.

The pizza handling module 1266 builds the pizza via communicating with the PLC.

Additionally, in embodiments, the pizza-making process is divided into zones (e.g., pizza construction, cooking, final preparation and smart storage) such that up to 4 pizzas can be processed/made at the same time.

In embodiments of the invention, a HLC 1110 and programmable logic controller (PLC) 1120 are provided where the HLC does not directly accept/send signals from/to motors and sensors and instead talks to the low level controller, namely, the PLC. The PLC 1120 is programmed to listen to the HLC 1110 and activate the subsystems through a PLC—HLC handshake protocol.

Also, in preferred embodiments, all parts of the stations and system that contact ingredients are fabricated with food contact safe materials.

Still other modifications and variations can be made to the disclosed embodiments without departing from the subject invention. For example, the invention is not intended to be limited to the type and number of stations described above. It is to be understood the functional modules may be arranged differently than that shown, and additional functional units may be added to the system to increase throughput as desired. Additionally, in embodiments, the automated pizza-making system may have less functional stations and components than that shown and described herein. Additionally, the order of the functional stations may vary from that described above. Indeed, the invention is intended to include a wide range of functional station configurations except where excluded from any appended claims.

1. An automated pizza-making system comprising:
a plurality of functional stations, the functional stations comprising:
a dough storage station for storing at least one rack, the dough storage station adapted to support a plurality of pizza dough tray assemblies in a vertical arrangement; and wherein a pizza dough translator is operable to move a pizza dough tray assembly from the dough storage station along a pizza assembly path;
a plurality of ingredient dispensing stations arranged about the pizza assembly path to dispense the ingredients on top of the pizza dough as the pizza dough tray assembly is moved along the pizza assembly path;
a cooking station comprising an oven; and wherein an oven loader is operable to move the pizza dough tray assembly from the pizza dough translator into the oven station after the ingredients have been dispensed onto the pizza dough;
a pizza slicer station for slicing the pizza after the tray has been separated from the pizza dough;
a pizza boxing station for enclosing a single cooked pizza in a closed box;
a smart storage station comprising a pizza box translator and a plurality of lockers in which the pizza box translator is operable to selectively place one closed box into one of the lockers for a customer pickup; and
a computer system programmed and operable to control the pizza dough storage station, the pizza dough translator, each of the ingredient dispensing stations, the oven station, the oven loader, the boxing station, and the smart storage station to automatically build, cook, slice, box, and store in a designated locker a cooked pizza based on a customer order.

2. The system of claim 1, further comprising a body or pod in which all the functional stations are enclosed.

3. The system of claim 2, further comprising a power distribution circuit comprising a power receptable or outlet operable to accept an AC power supply from an external source, a rectifier, and a plurality of conductor paths to distribute power to each of the functional stations and the computer system.

4. The system of claim 2, further comprising a frame to which each of the plurality of functional stations are mounted.

5. The system of claim 2, wherein the pod defines a footprint, and the plurality of functional components are arranged within the pod in a configuration that occupies the entire footprint, thereby prohibiting a worker from fitting within the pod during operation.

6. The system of claim 2, wherein the ingredient dispensing stations are arranged in a fixed position relative to the pizza assembly path.

7. The system of claim 6, comprising a transparent window through which the pizza assembly path is visible from the outside of the pod.

8. The system of claim 1, wherein the boxing station comprises a magazine of flat packed boxes, and operable to deploy one flat packed box from the magazine to a pizza loading stage.

9. The system of claim 8, wherein the boxing station is operable to unflatten the flat packed box, thereby defining a cavity to receive the cooked pizza.

10. The system of claim 9, wherein the boxing station is operable to close the upright box.

11. The system of claim 10, wherein the boxing station includes an arm member operable to rotate a window about a hinge, thereby closing the box.

12. The system of claim 1, wherein the pizza cutting station comprises a turntable for rotating the pizza, a blade adjustable in the vertical and horizontal directions, and wherein the computer system is operable to control the blade and turntable to create predefined cut pattern in the cooked pizza.

13. The system of claim 12, wherein the pre-defined cut pattern comprises a plurality of angularly-distributed, elongate linear cuts extending through the center of the pizza, each of which terminates an off-set distance from the edge of the pizza.

14. The system of claim 13, wherein the off-set distance is at least 0.25 inches.

15. The system of claim 14, wherein the blade is a rotatable, and wherein the pizza cutting station comprises a cleaner assembly, and wherein the computer system is operable to rotate the blade through the cleaner assembly to wipe the blade clean.

16. The system of claim 1, further comprising a pizza tray removal station for separating the pizza dough from the tray after cooking.

17. A self-contained portable automated pizza-making system comprising a first group of functional stations defining a cold pizza flowpath, and a second group of functional stations defining a hot pizza flowpath, and a computer system operable with the functional stations to prepare a pizza for cooking along the cold pizza flowpath, and cook and box the pizza along the hot pizza flowpath.

18. The automated pizza-making system of claim 17, wherein the cold pizza flowpath is arranged on a first frame such that the cold pizza flowpath may be separated from the hot pizza flowpath as a first unit, and optionally, the hot pizza flowpath is also arranged on a second frame to form a second unit.

19. The automated pizza-making system of claim 18, wherein the footprint of the cold pizza flowpath is less than or equal to half the overall footprint of the system.

20. The automated pizza-making system of claim 18, further comprising a transparent window to view the cold flowpath.

21. A method for automatically boxing a pizza comprising:
unflattening a flat packed box to form a cavity comprising a front window, rear window, top, bottom, and opposing side walls;
advancing the pizza through the front window and into the cavity;
enclosing the pizza in the box by closing the front and rear windows about hinges.

22. The method of claim 21, further comprising locking the windows via tab members.

23. The method of claim 21, wherein the step of unflattening is performed by automatically pushing on seams of the opposing side walls of the flat packed box from opposite directions, causing the top to separate from the bottom.

24. The method of claim 21, wherein the unflattened box defines a maximum volume, and the step of enclosing is performed within the maximum volume.

25. The method of claim 21, further comprising singulating the flat packed box from a magazine of vertically stacked flat packed boxes.
